(19) United States
(12) Patent Application Publication
(10) Pub. No.: US 2015/0177881 A1
(43) Pub. Date: Jun. 25, 2015

(54) TOUCH DISPLAY PANEL AND TOUCH DISPLAY APPARATUS USING SAME

(71) Applicant: Ye Xin Technology Consulting Co., Ltd., Hsinchu (TW)

(72) Inventor: Chung-Chun CHEN, Hsinchu (TW)

(21) Appl. No.: 14/524,577

(22) Filed: Oct. 27, 2014

(30) Foreign Application Priority Data
Dec. 24, 2013 (TW) 102147853

(51) Int. Cl. G06F 3/044; G09G 3/36

(52) U.S. Cl. CPC G06F 3/044; G09G 3/3648

(57) ABSTRACT

A touch display panel is capable of operating under a display period or a touch sensitive period. The touch display panel includes a touch sensitive electrode layer, a common electrode layer, and a display driving structure sandwiched between the touch sensitive electrode layer and the common electrode layer. The display driving structure includes a plurality of first driving lines, a plurality of pixel electrodes, and a plurality of switch units respectively connected to a specified first driving line and a specified pixel electrode. A touch scan controlling signal is applied to the common electrode layer during the touch sensitive period, and a first compensated signal is applied to each of the first driving lines orderly in a first predetermined time interval, the common electrode layer cooperates with the touch sensitive electrode layer to detect touch operations on the touch display apparatus.

### CROSS-REFERENCE TO RELATED APPLICATIONS

This application claims priority to Taiwan Patent Application No. 102147853 filed on Dec. 24, 2013 in the China Intellectual Property Office, the contents of which are incorporated by reference herein.

### FIELD

The present disclosure relates to a touch display panel and a touch display device using the same.

### BACKGROUND

Embedded touch display panels include a liquid crystal panel and a touch sensitive structure embedded in the liquid crystal panel. Parasitical capacitances may be formed in the embedded touch display panel.

### BRIEF DESCRIPTION OF THE FIGURES

Implementations of the present technology will now be described, by way of example only, with reference to the attached figures.

FIG. 1 is an isometric view of an embodiment of a touch display apparatus with a common electrode layer, a touch sensitive electrode layer, and a display driving structure.

FIG. 2 is an exploded, isometric view of an embodiment of the touch display apparatus of FIG. 1.

FIG. 3 is a diagrammatic view of an embodiment of the display driving structure of FIG. 1.

FIG. 4 is a diagrammatic view of an embodiment of the sensitive circuit common electrode layer and the touch sensitive electrode layer of FIG. 1, the comprising a sensitive circuit and an acquiring unit.

FIG. 5 is a circuit diagram of an embodiment of the acquiring unit of FIG. 4.

FIG. 6 is a diagram of waveforms of an embodiment of the touch display apparatus of FIG. 1.

FIG. 7 is an exploded, isometric view of another embodiment of the touch display apparatus of FIG. 1.

FIG. 8 is a diagrammatic view of an embodiment of the display driving structure and the common electrode layer of FIG. 7.

FIG. 9 is a diagrammatic view of an embodiment of the common electrode layer and the touch sensitive electrode layer of FIG. 7.

FIG. 10 is a diagrammatic view of another embodiment of the common electrode layer and the touch sensitive electrode layer of FIG. 7.

FIG. 11 is a diagram of waveforms of an embodiment of the touch display apparatus in operation of FIG. 7.

FIG. 12 is a diagram of waveforms of another embodiment of the touch display apparatus in operation of FIG. 7.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

A common electrode layer in a touch display apparatus capable of serving as a driving electrode for displaying images in a display period or serving as a driving electrode for sensing touch operations in a touch sensitive period is described.

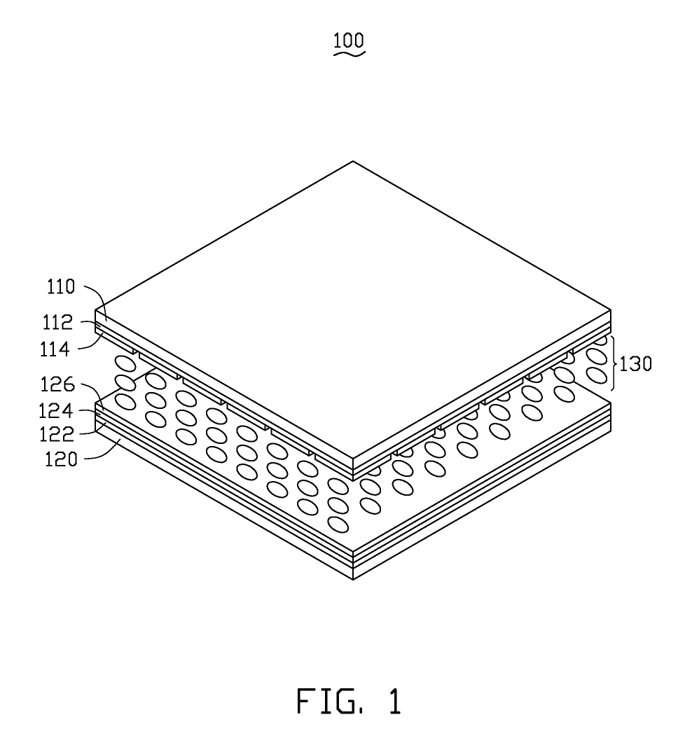

FIG. 1 illustrates an embodiment of a touch display apparatus 100. The touch display apparatus 100 includes a first substrate 110, a second substrate 120, and a liquid crystal layer 130 sandwiched between the first substrate 110 and the second substrate 120. In at least one embodiment, the touch display apparatus 100 is an embedded touch display apparatus.

The first substrate 110 includes a color filter layer 112 and a touch sensitive electrodes layer 114. In at least one embodiment, the color filter layer 112 is located on a surface of the first substrate 110 adjacent to the liquid crystal layer 130, and the touch sensitive electrodes layer 114 is located on a surface of the color filter layer 112 adjacent to the liquid crystal layer 130.

The second substrate 120 includes a common electrodes layer 122, an insulated layer 124, and a display driving structure 126. In at least one embodiment, the common electrodes layer 122 is located on a surface of the second substrate 120 adjacent to the liquid crystal layer 130, the insulated layer 124 is located on a surface of the common electrodes layer 122 adjacent to the liquid crystal layer 130, the display driving structure 126 is located on a surface of the insulated layer 124 adjacent to the liquid crystal layer 130, and an initial alignment of the liquid crystal layer 130 is a horizontal alignment.

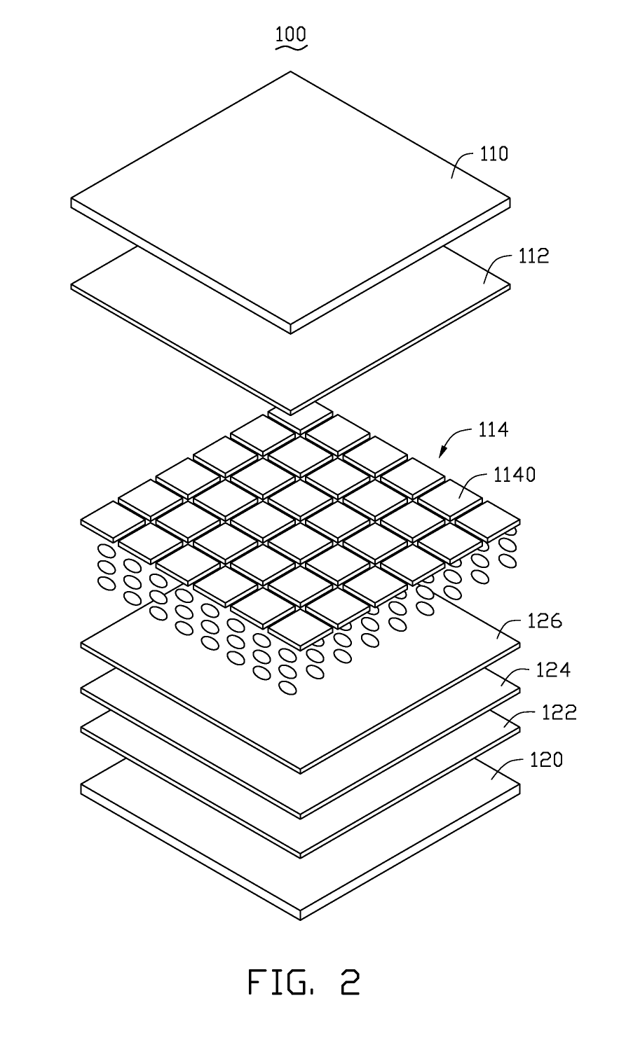

FIG. 2 illustrates the touch sensitive electrodes layer 114 includes a plurality of touch sensitive pad electrodes 1140. The touch sensitive electrodes 1140 are arranged in a matrix. The touch sensitive electrodes layer 114 cooperates with the common electrode layer 122 to form a self-sensing capacitive touch structure for sensing touch operation on the touch display apparatus 100 while the touch sensitive period. The common electrode layer 122 is a single side electrode layer. The display driving structure 126 insulates with the common electrode layer 122 by the insulating layer 124, and cooperates with the common electrode layer 122 for driving the touch display apparatus 100 to display images while the displaying period.

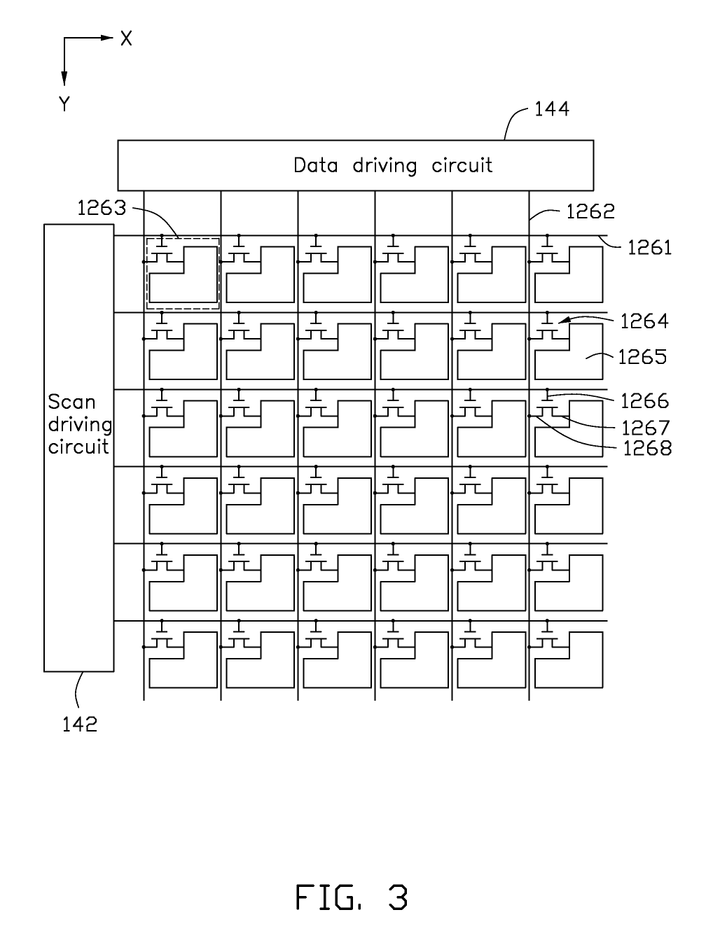

FIG. 3 illustrates that the display driving structure 126 includes a plurality of first driving lines 1261 parallel with each other along a first direction X, a plurality of second driving lines 1262 parallel with each other along a second direction Y, and a plurality of pixel regions 1263. The second driving line 1262 insulates with the first driving lines 1261. The pixel regions 1263 are defined by the intersecting first driving lines 1261 and the second driving lines 1262. Each of the pixel regions 1263 includes a switch unit 1264 and a pixel electrode 1265. The switch unit 1264 connects to the first driving lines 1261, the second driving lines 1262, and the pixel electrode 1265. The pixel electrode 1265 cooperates with the common electrode layer 122 for driving the touch display apparatus 100 to display images while the displaying period. In at least one embodiment, the first driving line 1261 is a scanning line, and the second driving ling 1262 is a data line. The first direction X is perpendicular to the second direction Y for making the pixel region 1263 arranged in a matrix. The switch unit 1264 includes a controlling terminal 1266, a first conducting terminal 1267, and a second conducting terminal 1268. The controlling terminal 1266 is connected to the corresponding first driving line 1261, the first conducting terminal 1267 is connected to the corresponding second driving line 1262, and the second conducting terminal 1268 is connected to the corresponding pixel electrode 1265. The switch unit 1264 is a thin film transistor. The controlling terminal 1266 is a gate of the transistor, the first conducting terminal 1267 is a source of the transistor, and a second conducting terminal 1268 is a drain of the transistor. In at least one embodiment, the pixel electrode 1265 and the common electrode layer 122 are located on the second substrate 120 to form a plane field for driving liquid crystals in the liquid crystal layer 130 to rotate in a specified plane.

The touch display apparatus 100 further includes a scan driving circuit 142 and a data driving circuit 144. The scan driving circuit 142 is connected to the first driving line 1261 for generating different signals in different period. The data driving circuit 144 is connected to the second driving line 1262 for generating different signals to the second driving line 1262 in different periods. While in displaying period, the scan driving circuit 142 generates a scan driving signal and the data driving circuit 144 generates a data driving signal. While in the touch sensitive period, the scan driving circuit 142 generates a first compensated signal, and the data driving circuit 144 generates a second compensated signal.

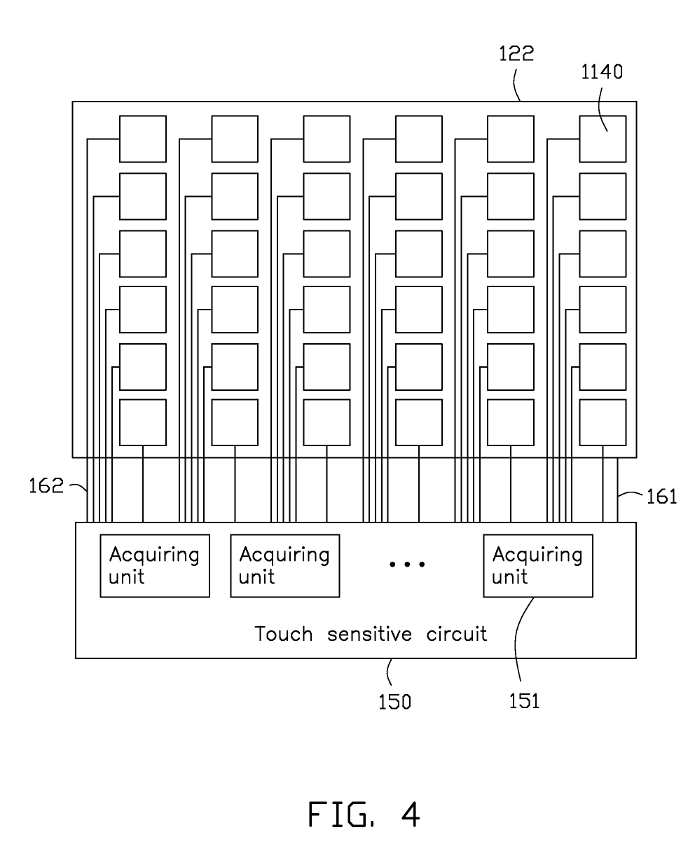

FIG. 4 illustrates the touch display apparatus 100 further includes a sensitive circuit 150. The sensitive circuit 150 includes a plurality of acquiring units 151. The common electrode layer 122 is connected to the sensitive circuit 150 through a first connecting line 161. The touch sensitive electrode 1140 is connected to the corresponding acquiring unit 151 through a second connecting line 162.

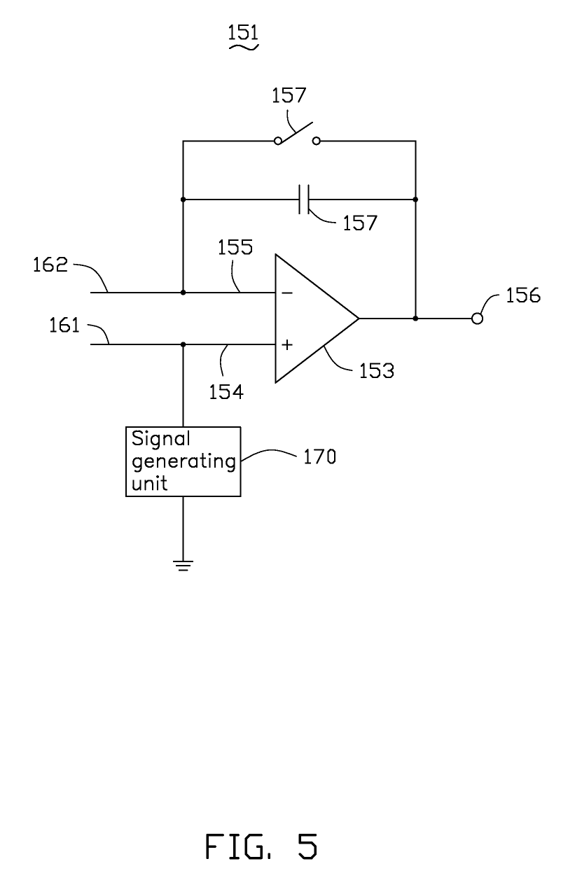

FIG. 5 illustrates that the acquiring unit 151 includes an amplifier 153, a capacitor 157, and a switch 158. The amplifier 153 includes a first inputting terminal 154, a second inputting terminal 155, and an outputting terminal 156. The first inputting terminal 154 is connected to the first connecting line 161 for receiving touch controlling signal. The second inputting terminal 155 is connected to the second connecting line 162 for detecting voltage on the touch sensitive electrode 1140. The capacitor 157 and the switch 158 are connected between the second inputting terminal 155 and the outputting terminal 156 in parallel. In at least one embodiment, the touch display apparatus 100 further include a signal outputting unit 170. The signal generating unit 170 is connected to the first inputting terminal 154 and the common electrode layer 122 through the first connecting 161. The signal generating unit 170 generates a touch controlling signal Vt1 to the common electrode layer 122 while the touch sensitive period, and generates a common voltage signal to the common electrode layer 122 while the display period.

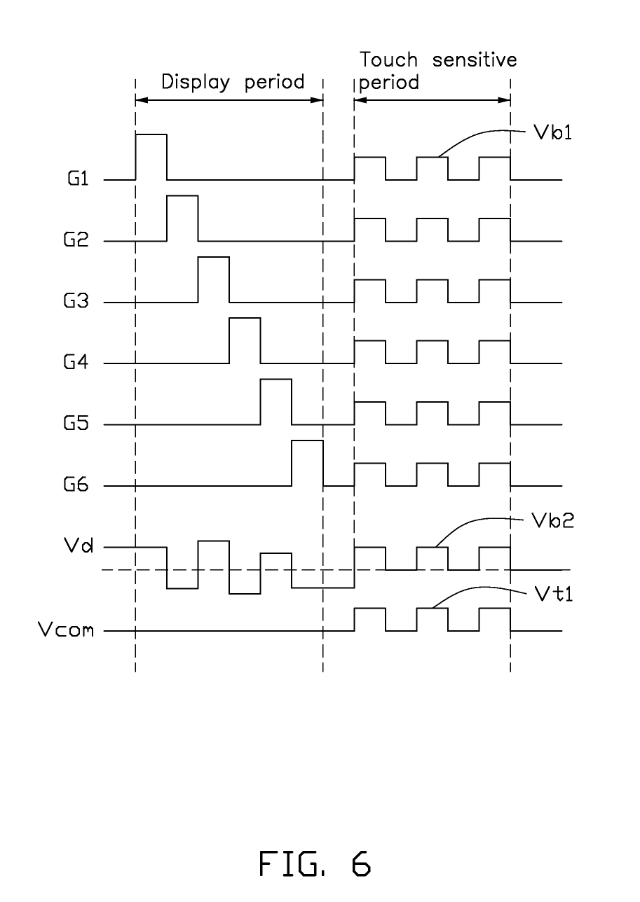

FIG. 6 illustrates that the waveforms of the touch display apparatus 100 in operation. G1-G6 respectively represent signals applied to the first driving lines 142 provided by the scan driving circuit 142. Vd represents a signal applied to the second driving line 1262 provided by the data driving circuit 142. Vcom represents a signal applied to the common electrode layer 122 provided by the signal generating unit 170. In other embodiment, there are more than six first driving lines 1261 and more than six second driving lines 1262.

In display period, the scan driving circuit 142 orderly generates a plurality of scan driving signals to all of the first driving lines 1261 in a first predetermined time interval, the common electrode layer 122 is being applied by a directed specified voltage which is represented as a common voltage signal, and the data driving circuit 144 orderly generates data driving signals to the second driving lines 1262 in a second predetermined time interval. The switch unit 1264 corresponding to the first driving signal 1261 received the scan driving signal turns on for writing the data signal into the corresponding pixel electrode 1265 by the corresponding second driving line 1262. Thus, the pixel electrode 1265 and the common electrode layer 1222 forms a plane electrical filed for driving the liquid crystals in the liquid crystal layer 130 to rotate in the formed plane, and the touch display apparatus 100 displays images. In other embodiments, the common electrode layer 122 is applied by a square wave alternating voltage with the polarities reversal in turn which is represented as the common voltage signal.

In the touch sensitive period, the scan driving circuit 142 orderly generates the first compensated signals Vb1 to all of the first driving lines 1261 in the first predetermined time interval, the data driving circuit 144 respectively generates the second compensated signals Vb2 to the second driving lines 1262 in the second predetermined time interval, the common electrode layer 122 detects voltage change on the touch sensitive electrodes 1140 for indentifying the touch operations on the touch display apparatus 100 through the corresponding acquiring unit 151 based on received touch controlling signal Vt1. In at least one embodiment, phases and amplitudes of the first compensated signal Vb1, the second compensated signal Vb2, and the touch controlling signal Vt1 are the same. The touch controlling signal Vt1 can be a continues square wave. In other embodiments, the touch controlling signal Vt1 can be a continues sine wave or a continues triangular wave.

Effects of parasitical capacitances formed between the first driving lines 1261 and the common electrode layer 122, the second driving lines 1262 and the common electrode layer 122, and the third driving lines 1263 and the common electrode layer 122 are reduced by the first compensated signal Vb1 and second compensated signal Vb2 while the touch sensitive period, thus the stabilization and the reliability of the touch display apparatus 100 is increased.

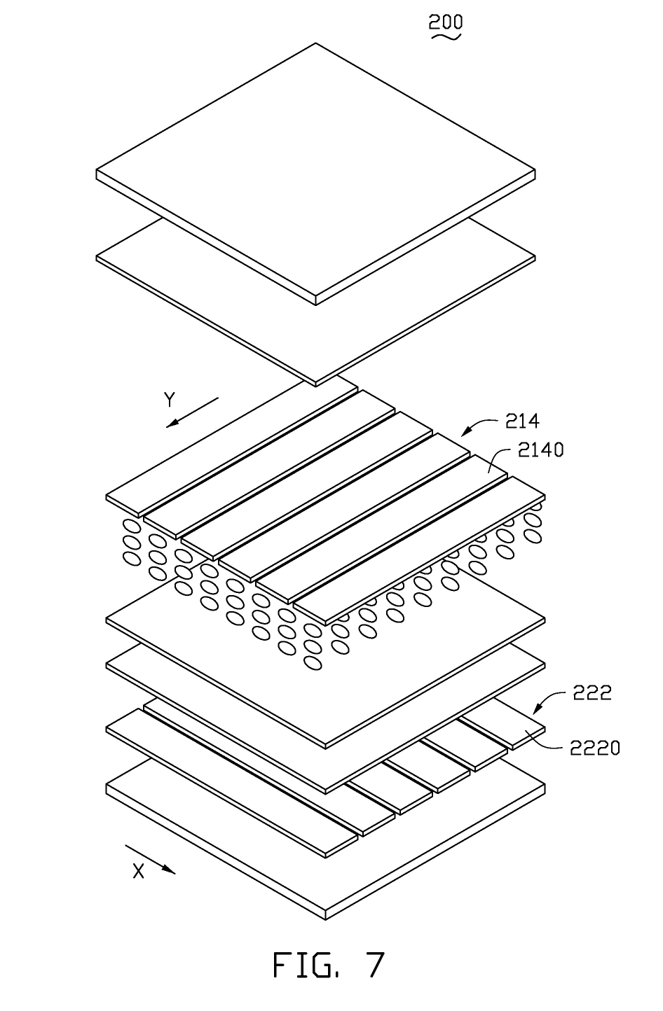

FIG. 7 illustrates the structure of the touch electrode layer 214 and the common electrode layer 222 in another embodiment. The touch electrode layer 214 includes a plurality of first electrodes 2140, and the common electrode layer 222 includes a plurality of second electrodes 2220. Each of the first electrodes 2140 are arranged along the first direction X, and each of the second electrodes 2220 are arranged along the second direction Y. A touch sensitive capacitance C is formed at the intersected first electrode 2140 and the second electrode 2220.

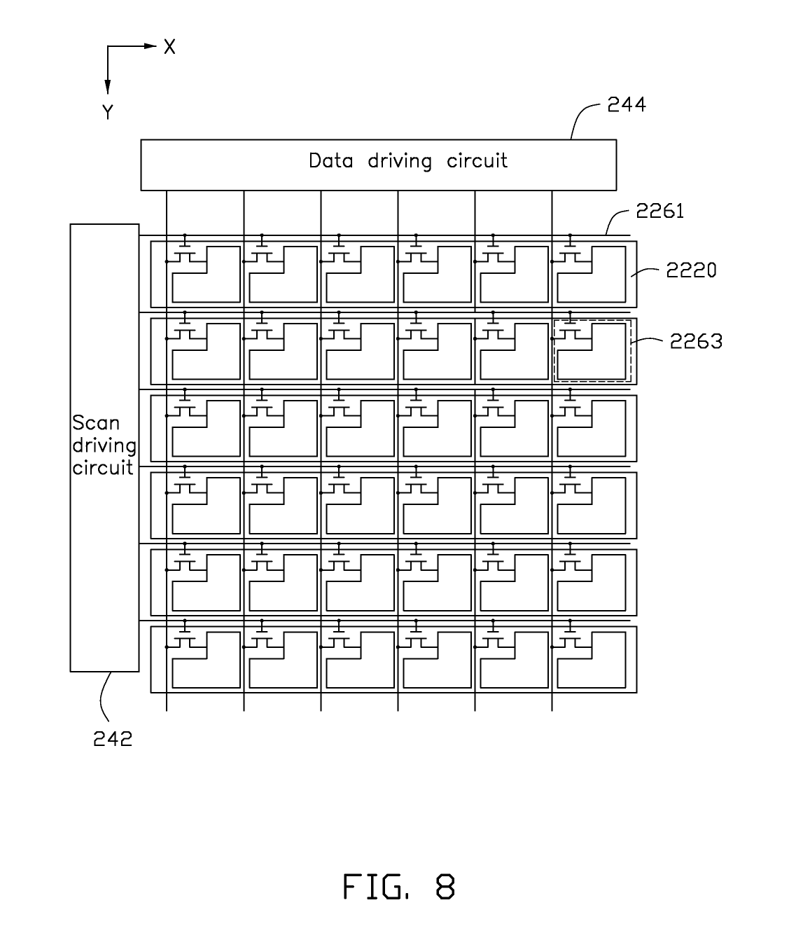

FIG. 8 illustrates the display driving structure 226 and the common electrode layer 222 in another embodiment. The first driving lines 2261 corresponds to the first electrodes 2140 in an one-to-one relationship, and the pixel regions 2263 corresponds to the second electrode 2220 in an one-to-one relationship.

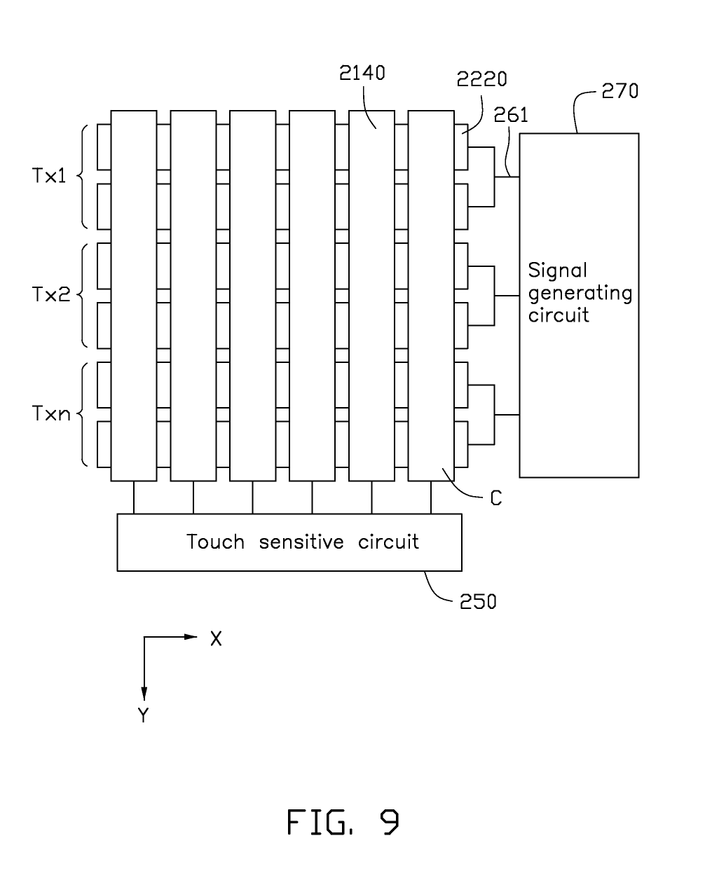

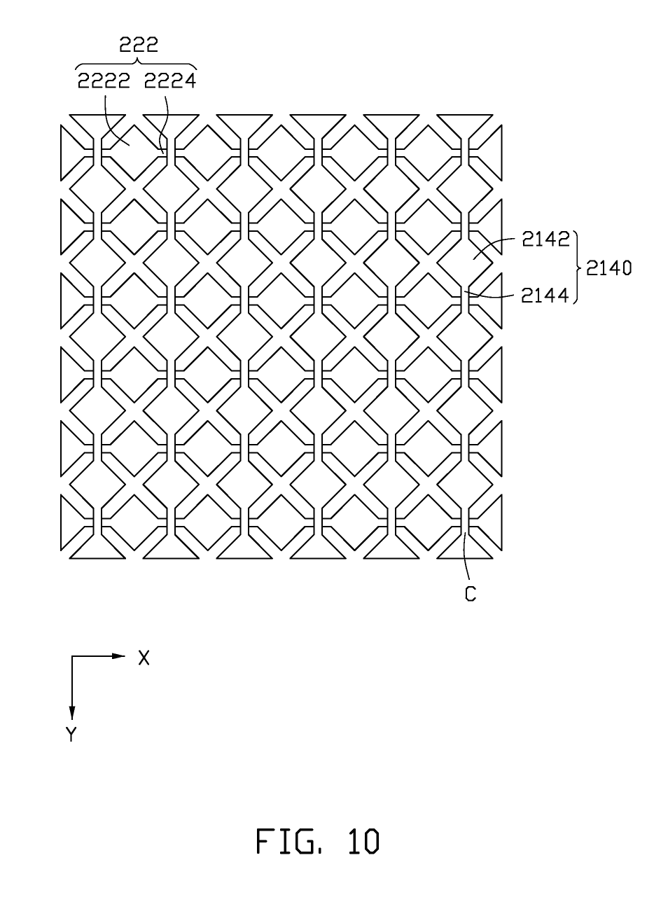

FIG. 9 illustrates the common layer 222 and the touch sensitive electrode layer 214 in another embodiment. The second electrodes 2220 are divided into a plurality of teams TX1-TXn. Each of the teams TX1-TXn includes at lest two second electrodes 2220 connecting with the signal generating circuit 270 via the first connecting line 261. In at least embodiment, there are three teams TX1-TX3, and each of the three teams TX1-TX3 includes two second electrodes 2220. The second electrode 2220 is substantially rectangular shaped. In other embodiment, the second electrode 2220 is substantially rhombic shaped (as shown in FIG. 10).

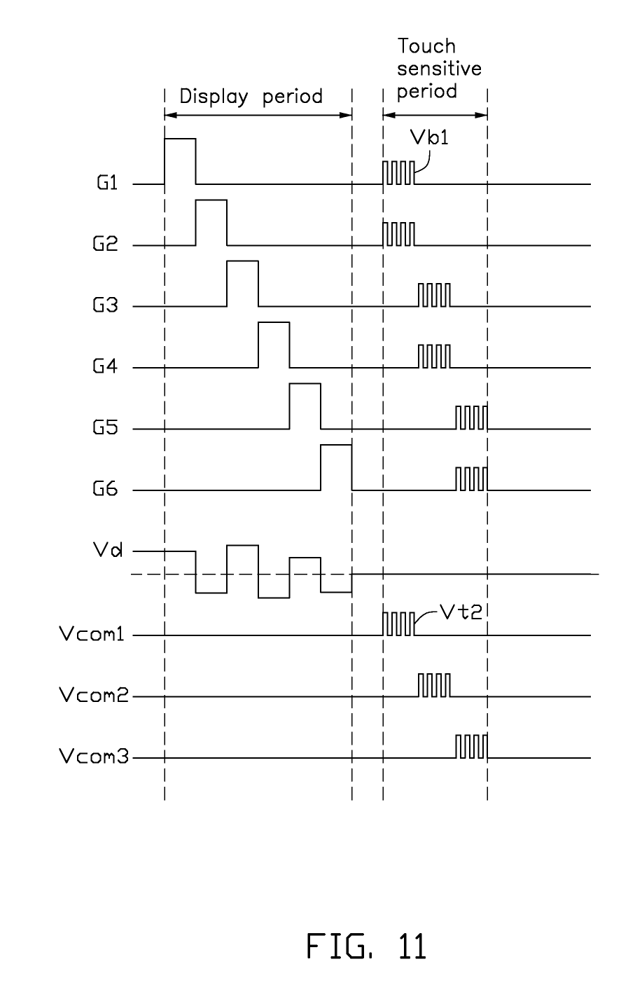

FIG. 11 illustrates that the waveforms of the touch display apparatus 100 in FIG. 7. G1-G6 respectively represent signals applied to the first driving lines 242 provided by the first driving line 2611. Vd represents a signal applied to the second driving line 2612 provided by the data driving circuit 244. Vcom1-Vcom3 represent signals applied to the teams TX1-TXn provided by the signal generating unit 270.

In display period, the scan driving circuit 242 orderly generates a plurality of scan driving signals to all of the first driving lines 2611 in a first predetermined time interval, the second electrodes 2220 of the common electrode layer 222 are applied by a direct specified voltage signal which is represented as a common voltage signal, and the data driving circuit 244 orderly generates data driving signals to all of the second driving lines 2612 in a second predetermined time interval. The operational principle of the touch display apparatus 100 in FIG. 7 is similar as the operational principle of the touch display apparatus 100 in FIG. 2.

In the touch sensitive period, the signal generating circuit 270 orderly generates a touch scan signal Vt2 as a touch controlling signal to the teams TX1-TXn in a third predetermined time interval. In at least embodiment, at anytime, a specified team TXi receives the touch controlling signal Vt2, and the at least second electrodes 2220 in the specified team TXi receives the touch controlling signal simultaneously. The scan driving circuit 242 generates the first compensated signal Vb1 to the first driving lines 2261 corresponding to the specified team TXi. In at least one embodiment, phases and amplitudes of the first compensated signal Vb1 and the touch controlling signal Vt1 are the same. The touch controlling signal Vb1 can be a continues square wave. The touch controlling signal includes a plurality of continues pulses. The second driving line 2262 is being applied by a specified direct voltage, such as 0 volt, or being floated.

Effects of parasitical capacitances formed between the first driving lines 2261 and the common electrode layer 222 is reduced by the first compensated signal Vb1 applied to the first driving lines 2261 while the touch sensitive period, thus the stabilization and the reliability of the touch display apparatus 100 is increased.

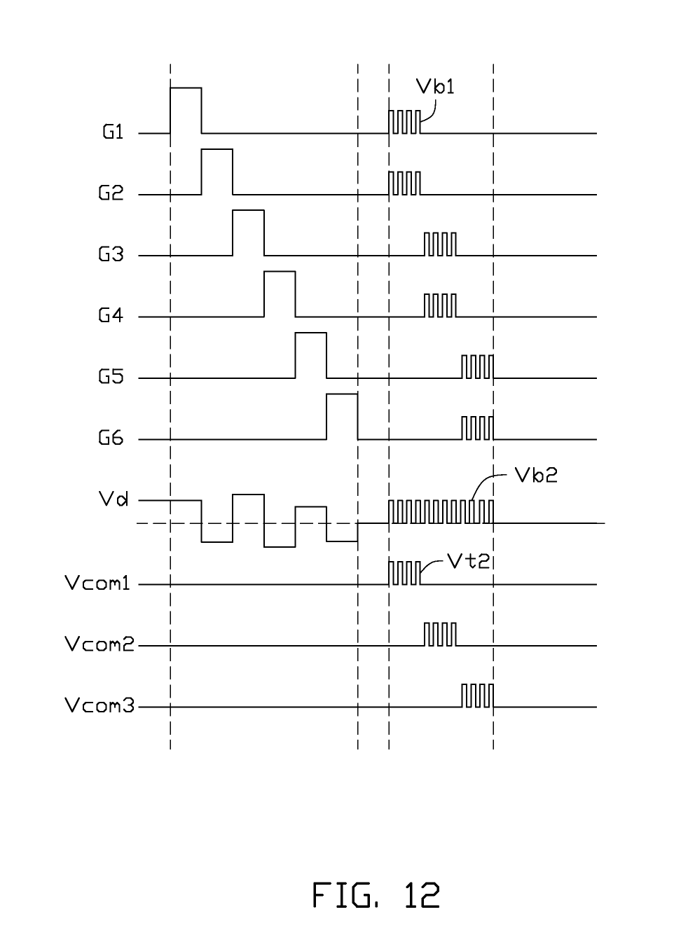

FIG. 12 illustrates that another waveforms of the touch display apparatus 100 in FIG. 7, the data driving circuit 244 generates the second compensated signal Vb2 to the second driving lines 2612 in the second predetermined time interval. In at least one embodiment, the second compensated signal Vb2 includes a plurality of continues pulses, and the second compensated signal Vb2 is equal to a superposition of the touch scan signals Vcom1-Vcom3, and phase and the amplitude of the second compensated signal Vb2 and touch can signals Vcom1-Vcom3 are the same.

Effects of parasitical capacitances formed between the first driving lines 2261 and the common electrode layer 222, the second driving lines 2262 and the common electrode layer 222 is reduced by the first compensated signal Vb1 applied to the first driving lines 2261 and the second compensated signal Vb2 while the touch sensitive period, thus the stabilization and the reliability of the touch display apparatus 100 is increased.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including matters of shape, size, and arrangement of the parts within the principles of the present disclosure, up to and including the full extent established by the broad general meaning of the terms used in the claims.

What is claimed is:

1. A touch display panel capable of operating under a display period or a touch sensitive period, the touch display panel comprising:
a touch sensitive electrode layer;
a common electrode layer; and
a display driving structure connected between the touch sensitive electrode layer and the common electrode layer, the display driving structure comprising:
a plurality of first driving lines;
a plurality of pixel electrodes; and
a plurality of switch units respectively connected to a specified first driving line from among the plurality of first driving lines and a specified pixel electrode from among the plurality of pixel electrodes;
wherein a direct specified voltage is applied to the common electrode layer in cooperation with the corresponding pixel electrode during the display period;
a touch scan controlling signal is applied to the common electrode layer during the touch sensitive period, and a first compensated signal is applied to each of the first driving lines orderly in a first predetermined time interval; and
the common electrode layer cooperates with the touch sensitive electrode layer to detect touch operations on the touch display apparatus.

2. The touch display panel of claim 1, wherein phases and amplitudes of the first compensated signal and the touch scan controlling signal are the same.

3. The touch display panel of claim 1, wherein the display driving structure further comprising a plurality of second driving lines; the second driving lines are intersected and insulated with the first driving lines; the switch unit is further connected to the second driving lines; the switching unit comprises a controlling terminal, a first conducting terminal, and a second conducting terminal; the controlling terminal is connected to a specified first driving line, the first conducting terminal is connected to a specified second driving line, and the second conducting terminal is connected to a specified pixel electrode.

4. The touch display panel of claim 1, further comprising an acquiring unit; wherein the touch sensitive electrode layer comprises a plurality of touch sensitive electrodes arranged in a matrix; the touch sensitive electrode is connected to a specified acquiring unit; the common electrode layer detects voltage change on the touch sensitive electrodes for indentifying touch operations on the touch display panel via the acquiring unit.

5. The touch display panel of claim 4, wherein the acquiring unit comprises an amplifier, a capacitor, and a switch; the amplifier comprises a first inputting terminal, a second inputting terminal, and an outputting terminal; the first inputting terminal is connected to the common electrode layer for receiving touch controlling signal; the second inputting terminal is connected to the touch sensitive electrode layer for detecting voltage on the touch sensitive electrode; the capacitor and the switch are connected between the second inputting terminal and the outputting terminal in parallel.

6. The touch display panel of claim 3, wherein the common electrode layer comprises a plurality of common electrodes corresponding to the first driving lines in an one-to-one relationship; the common electrodes are divided into a plurality of teams; the teams are orderly being applied by a touch controlling signal; in anytime, a specified team is being applied by the touch controlling signal, and the first driving lines corresponding to the specified team are being applied by the first compensated signal simultaneously.

7. The touch display panel of claim 3, wherein under the touch sensitive period, a second compensated signal is applied to each of the second driving lines orderly in a second predetermined time interval; the second compensated signal is equal to a superposition of the touch scan signals applied on different teams of second electrodes of the common electrode layer.

8. The touch display panel of claim 7, wherein phases and amplitudes of the second compensated signal and the touch scan controlling signal are the same.

9. The touch display panel of claim 3, wherein under the touch sensitive period, the second driving lines are being applied by a direct specified voltage or floated.

10. A touch display apparatus capable of operating under a display period or a touch sensitive period; the touch display apparatus comprising:
a first substrate with a touch sensitive layer;
a second substrate with a common electrode layer;
a liquid crystal layer with a plurality of liquid crystals sandwiched between the first substrate and the second substrate; and
a display driving structure connected between the touch sensitive electrode layer and the common electrode layer, the display driving structure comprising:
a plurality of first driving lines;
a plurality of pixel electrodes; and
a plurality of switch units connected to a specified first driving line from among the plurality of first driving lines and a specified pixel electrode from among the plurality of pixel electrodes;
wherein the touch sensitive layer cooperates with the common electrode layer to form a plane field for driving liquid crystals rotating in a specified plane; under the touch sensitive period, a touch scan controlling signal is applied to the common during the touch sensitive period, and a first compensated signal is applied to each of the first driving lines orderly in a first predetermined time interval, the common electrode layer cooperates with the touch sensitive electrode layer to detect touch operations on the touch display apparatus.

11. The touch display apparatus of claim 10, wherein the touch sensitive electrode layer comprises a plurality of first electrodes parallel with each other along a first direction; the common electrode layer comprises a plurality of second electrodes parallel with each other along a second direction; the first direction is angled with the second direction.

12. The touch display apparatus of claim 10, wherein the common electrode layer comprises a plurality of common electrodes corresponding to the first driving lines in an one-to-one relationship; the common electrodes are divided into a plurality of teams; the teams are orderly being applied by a touch controlling signal; in anytime, a specified team is being applied by the touch controlling signal, and the first driving lines corresponding to the specified team are being applied by the first compensated signal simultaneously.

13. The touch display apparatus of claim 12, wherein the display driving structure further comprising a plurality of second driving lines; the second driving lines are intersected and insulated with the first driving lines.

14. The touch display apparatus of claim 13, wherein under the touch sensitive period, a second compensated signal is applied to each of the second driving lines orderly in a second predetermined time interval.

15. The touch display apparatus of claim 14, wherein the second compensated signal is equal to the superposition of the touch scan signals applied to different teams of second electrodes of the common electrode layer.

16. The touch display apparatus of claim 13, wherein under the touch sensitive period, the second driving lines are being applied by a direct specified voltage or floated.

17. The touch display apparatus of claim 13, wherein phases and amplitudes of the first compensated signal, the second compensated signal, and the touch scan controlling signal are the same.

18. The touch display apparatus of claim 13, wherein the switch unit is further connected to the second driving lines; the switching unit comprises a controlling terminal, a first conducting terminal, and a second conducting terminal; the controlling terminal is connected to a specified first driving line, the first conducting terminal is connected to a specified second driving line, and the second conducting terminal is connected to a specified pixel electrode.

19. The touch display apparatus of claim 10, further comprising an acquiring unit; wherein the touch sensitive electrode layer comprises a plurality of touch sensitive electrodes arranged in a matrix; the touch sensitive electrode is connected to a specified acquiring unit; the common electrode layer detects voltage change on the touch sensitive electrodes for indentifying touch operations on the touch display panel via the acquiring unit.

20. The touch display apparatus of claim 19, wherein the acquiring unit comprises an amplifier, a capacitor, and a switch; the amplifier comprises a first inputting terminal, a second inputting terminal, and an outputting terminal; the first inputting terminal is connected to the common electrode layer for receiving touch controlling signal; the second inputting terminal is connected to the touch sensitive electrode layer for detecting voltage on the touch sensitive electrode; the capacitor and the switch are connected between the second inputting terminal and the outputting terminal in parallel.
